(19) United States
(12) Patent Application Publication
(10) Pub. No.: US 2004/0158841 A1
(43) Pub. Date: Aug. 12, 2004

(54) Method and apparatus for displaying a dialogue window of a device

(75) Inventors: Serafim Bochkarev, Gyeonggi-do (KR); Don-Seon Lee, Gyeonggi-do (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/772,285

(22) Filed: Feb. 6, 2004

(30) Foreign Application Priority Data
Feb. 8, 2003 (KR) 2003-8000

(51) Int. Cl. G06F 13/00

(52) U.S. Cl. 719/321

(57) ABSTRACT

A method and apparatus in which a device driver dialogue window of a device is displayable regardless of the number of bits supported by the operating system. The operating system supporting a first number of bits is requested to display the device driver dialogue window supporting a second number of bits, for exchange of information between a user and the device. The dialogue window information of the device in the first number of bits is received and converted into dialogue window information in the second number of bits and displayed.

### CROSS-REFERENCE TO RELATED APPLICATIONS

This application claims the priority benefit of Korean Patent Application No. 2003-8000 filed on 8 Feb. 2003 in the Korean Intellectual Property Office, the disclosure of which is incorporated herein in its entirety by reference.

### BACKGROUND OF THE INVENTION

1. Field of the Invention

The present invention relates to a device driver that an operating system (OS) supports, and more particularly, to a method and apparatus for displaying a device driver dialogue window of a device.

2. Description of the Related Art

An operating system is a collection of system programs controlling the overall operations of a computer system. The operating system functions as an interface between hardware and application programs and manages computer resources, such as a CPU, a main memory device, and input/output devices. That is, the operating system provides a linkage between a computer and a human and simultaneously controls booting of the computer, sequence of processes, and input/output calculation. Also, the operating system controls execution of programs and manages storage of data and files. MICROSOFT WINDOWS is a typical operating system, and there are DOS, UNIX, LINUX, MAC OS for MACINTOSH computers, and so forth.

WINDOWS adopts a GUI (graphic user interface) which is a graphical work environment in which all commands or files used in a computer are presented as pictorial icons which can be selected and executed by using an input device, typically, a mouse. Thus, under the WINDOWS operating system, an input process can be simplified by using an iconic interface, allowing execution of a command when a user does not know well the name of the command or file, and multitasking enabling simultaneous executions of multiple programs is available. The WINDOWS operating system has a family of WINDOWS 95, WINDOWS 98, WINDOWS NT, WINDOWS 2000, and WINDOWS XP. Among them, WINDOWS 95 and WINDOWS 98 support 16 bit device drivers, while WINDOWS NT, WINDOWS 2000, and WINDOWS XP support 32 bit device drivers and feature a faster processing speed.

Typically, the conventional operating systems, such as WINDOWS 95 and WINDOWS 98, cannot support 32 bit device drivers, whereas other operating systems, such as WINDOWS NT, WINDOWS 2000, and WINDOWS XP cannot support 16 bit device drivers. Accordingly, a user should prepare a 16 bit device driver or a 32 bit device driver, even if they have the same purpose, according to the environment of a computer, that is, the type of an operating system. In other words, 16 bit device drivers should be prepared for an operating system supporting 16 bit device drivers, such as WINDOWS 95 or WINDOWS 98, while 32 bit device drivers should be prepared for another operating system supporting 32 bit device drivers, such as WINDOWS NT, WINDOWS 2000, and WINDOWS XP. Thus, in an environment in which the operating systems, such as WINDOWS 95, WINDOWS 98, WINDOWS NT, WINDOWS 2000, and WINDOWS XP, are selectively used, a 16 bit device driver and a 32 bit device driver are inconveniently prepared to perform the same purpose.

### SUMMARY OF THE INVENTION

The present invention provides a method of displaying a device driver dialogue window of a device using a single device driver regardless of the type of an operating system. The present invention also provides an apparatus displaying a device driver dialogue window of a device using a single device driver regardless of the type of an operating system.

Additional aspects and/or advantages of the invention will be set forth in part in the description which follows and, in part, will be obvious from the description, or may be learned by practice of the invention.

The present invention provides a method of displaying a dialogue window of a device performed by a device control portion, the method comprising requesting an operating system supporting a 16 bit device control portion to display a 32 bit dialogue window for exchange of information between a user and a predetermined device, receiving 16 bit dialogue window information of the device from the operating system, converting the received 16 bit dialogue window information to the 32 bit dialogue window information, and displaying the 32 bit dialogue window corresponding to the converted 32 bit dialogue window information.

The present invention may also be achieved by an apparatus displaying a dialogue window of a device which is included in a device control portion, the apparatus comprising a first interface portion receiving 16 bit dialogue window information of the device from a first operating system supporting a 16 bit device control portion, a second interface portion receiving 32 bit dialogue window information of the device from a second operating system supporting a 32 bit device control portion, a bit converting portion converting the received 16 bit dialogue window information to the 32 bit dialogue window information and outputting the converted 32 bit dialogue window information, in response to input of the 16 bit dialogue window information, and a dialogue window display portion displaying a 32 bit dialogue window corresponding to the 32 bit dialogue window information, in response to input of the converted 32 bit dialogue window information.

### BRIEF DESCRIPTION OF THE DRAWINGS

The above and/or other aspects and advantages of the invention will become apparent and more readily appreciated from the following description of the embodiments, taken in conjunction with the accompanying drawings in which:

FIG. 1 is a flow chart of displaying a dialogue window of a device, according to an embodiment of the present invention;

FIG. 2 is a flow chart of converting received 16 bit dialogue window information to 32 bit dialogue window information in operation 14 of FIG. 1, according to an embodiment of the present invention;

FIG. 3 is a screen display image of a base 32 bit dialogue window displayed according to a base 32 bit dialogue window information, according to an embodiment of the present invention;

FIG. 4 is a screen display image of a 32 bit dialogue window displayed by converting 16 bit dialogue window information to 32 bit dialogue window information, according to an embodiment of the present invention;

FIG. 5 is a functional block diagram of an apparatus displaying a device driver dialogue window, according to an embodiment of the present invention; and

FIG. 6 is a functional block diagram of a bit conversion portion of the device driver dialogue window display apparatus shown in FIG. 5.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

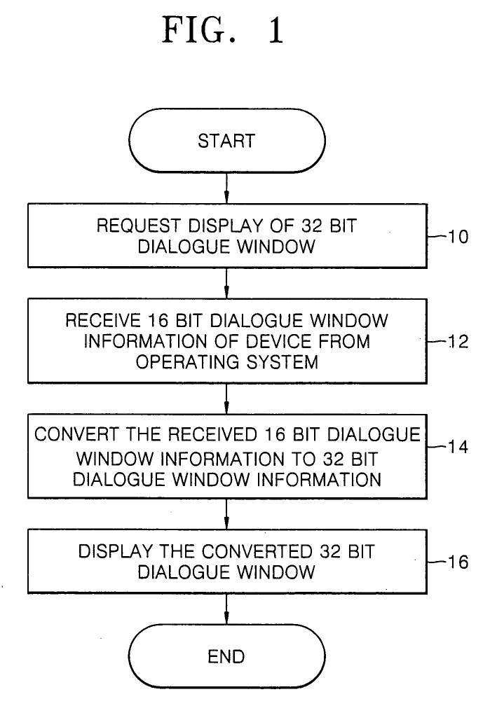

Referring to FIG. 1, a method of displaying a dialogue window of a device, according to an embodiment of the present invention comprises operations 10 through 16 for receiving 16 bit dialogue window information, converting the received information to 32 bit dialogue window information, and displaying a 32 bit dialogue window according to the converted 32 bit dialogue window information.

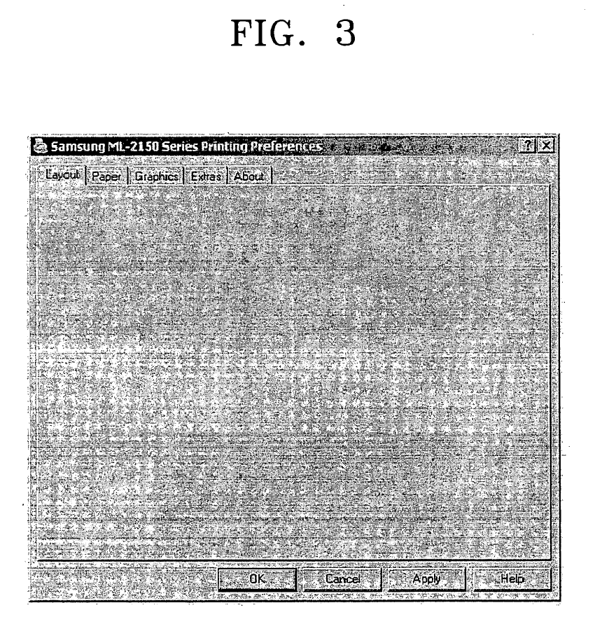

As an example, in a case of an operating system supporting a 16 bit device control portion (hereinafter for convenience referred to as the 16 bit operating system), if the 16 bit operating system is loaded/installed with the present invention's device driver, at operation 10, the 16 bit operating system is requested by an application program to display a 32 bit dialogue window of the device driver for exchange of information between a user and a predetermined device. More particularly, at operation 10, an application program, including a user, through the 16 bit operating system, requests the device driver to display a base 32 bit dialogue window according to a base 32 bit dialogue window information as shown in FIG. 3. The device may be any peripheral device or device requiring a device driver as an interface therewith, such as a printer, a scanner, an all-in-one device, etc. The 16 bit device control portion supported by the 16 bit operating system is a device driver to control a device performing a predetermined purpose by 16-bit strings. Hereinafter, the device driver is referred to as a device control portion. For example, an operating system supporting the 16 bit device control portion is WINDOWS 95 or WINDOWS 98. In this example, a 32 bit dialogue window of the device driver works as a passage for the exchange of information between the user and the device. The 32 bit dialogue window is realized by using a graphically displayed window as a user interface. The user requests display of the 32 bit dialogue window through a computer application program allowing interface with a device (e.g., selecting a print function in case of a printer device). Therefore, the present invention provides a single device driver that can accommodate (receive and display) dialogue window information from any number of bits operating systems, for example, from both a 16 bit operating system and a 32 bit operating system.

At operation 12, the 16 bit operating system provides 16 bit dialogue window information of the device to the requested device driver to display the 16 bit dialogue information in the 32 bit dialogue window (as will be described in more detail further below). The dialogue window information is data to configure a dialogue window, such as a control message of the device, data to configure/present an edge portion of the dialogue window, etc. The control message of the dialogue window information is a data (user interface) portion of the dialogue window presented to the user to give a control command to the device through the dialogue window (i.e., the control message is a graphical user interface displayed in the device driver dialogue window to control the device and provided by application program allowing an interface with the device). The device control portion receives the 16 bit dialogue window information of the device corresponding to the requested 32 bit dialogue window, from the operating system, such as WINDOWS 95 or WINDOWS 98, supporting the 16 bit device control portion.

At operation 14, the received 16 bit dialogue window information is converted to the 32 bit dialogue window information. The 16 bit dialogue window information comprising 16 bit strings with respect to a device dialogue window that the user desires to be displayed is converted to dialogue window information of 32 bit strings. At operation 16, the device driver displays the converted 32 bit dialogue window information in the 32 bit dialogue window.

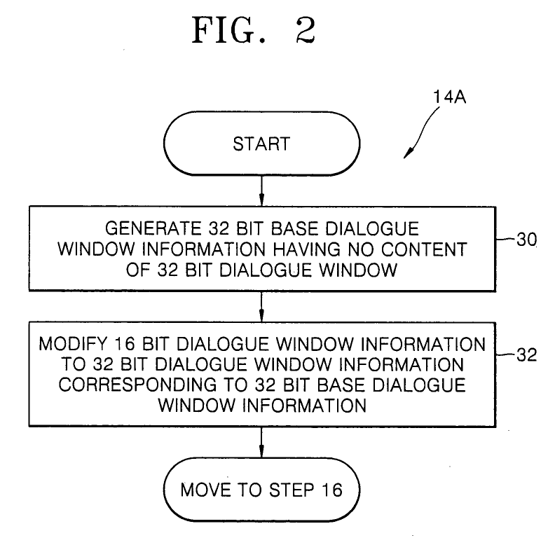

FIG. 2 is a flow chart of converting received 16 bit dialogue window information to 32 bit dialogue window information in operation 14 of FIG. 1, according to an embodiment 14A of the present invention. The dialogue window information conversion comprises modifying the 16 bit dialogue window information to 32 bit dialogue window information corresponding to the generated 32 bit base dialogue window information in operation 10.

More particularly, at operation 30, the 32 bit base dialogue window information having no content of a 32 bit dialogue window is generated as shown in FIG. 3. The 32 bit base dialogue window information having no content of a 32 bit dialogue window is dialogue window information in which a control message to a 32 bit dialogue window is not indicated (presented). The base dialogue window information is formed of 32-bit bit strings. FIG. 3 is a screen display image of a base 32 bit dialogue window without a control message according to a base 32 bit dialogue window information, according to an embodiment of the present invention.

At operation 32, the 16 bit dialogue window information received from the operating system is modified to 32 bit dialogue window information corresponding to the 32 bit base dialogue window information. Therefore, at operation 32, bit strings of the received bit dialogue window information are modified to bit strings of 32 bit dialogue window information corresponding to the 32 bit base dialogue window information provided in operation 30.

Referring back to FIG. 1, at operation 16, a 32 bit dialogue window corresponding to the converted 32 bit dialogue window information is displayed. More particularly, at operation 16, the 32 bit dialogue window that is requested by the user or the 16 bit operating system application program, is displayed by using the converted 32 bit dialogue window information. For example, the user may request one page information of a plurality of pages of the displayed 32 bit base dialogue window (i.e., in FIG. 3, the user can select one of the selectable graphical displays of tabs, such as ‘Layout’). The page information as a dialogue window control message includes detailed information in the 32 bit dialogue window that the user desires to be displayed for control of the device.

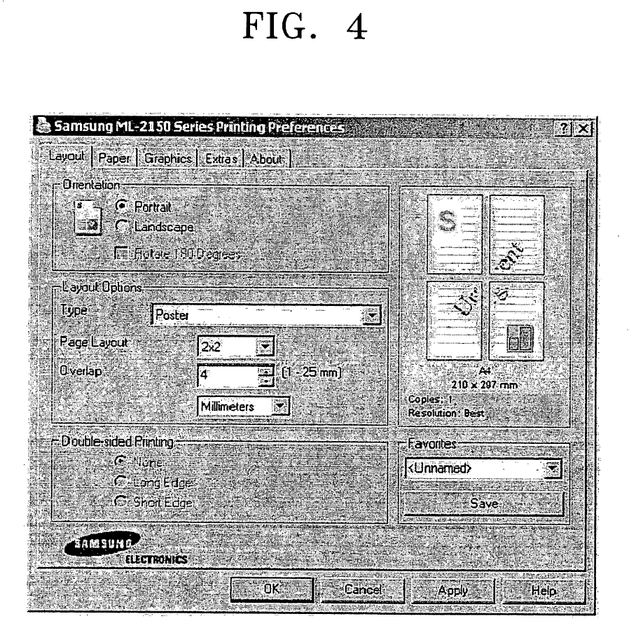

FIG. 4 is a screen display image of a 32 bit base dialogue window with a control message (page information), which is displayed by modifying/converting the 16 bit dialogue window information received from the 16 bit operating system application program to the 32 bit dialogue window information. The detailed selectable graphical displays of tab items such as layout, paper, and graphics shown in FIG. 4 correspond to the converted 32 bit page information/control message of the 32 bit dialogue window. At the request by the user, or the application program, for one of the page information of the 32 bit base dialogue window, the page information is provided by the application program through the operating system and displayed by being converted to 32 bits by the device driver.

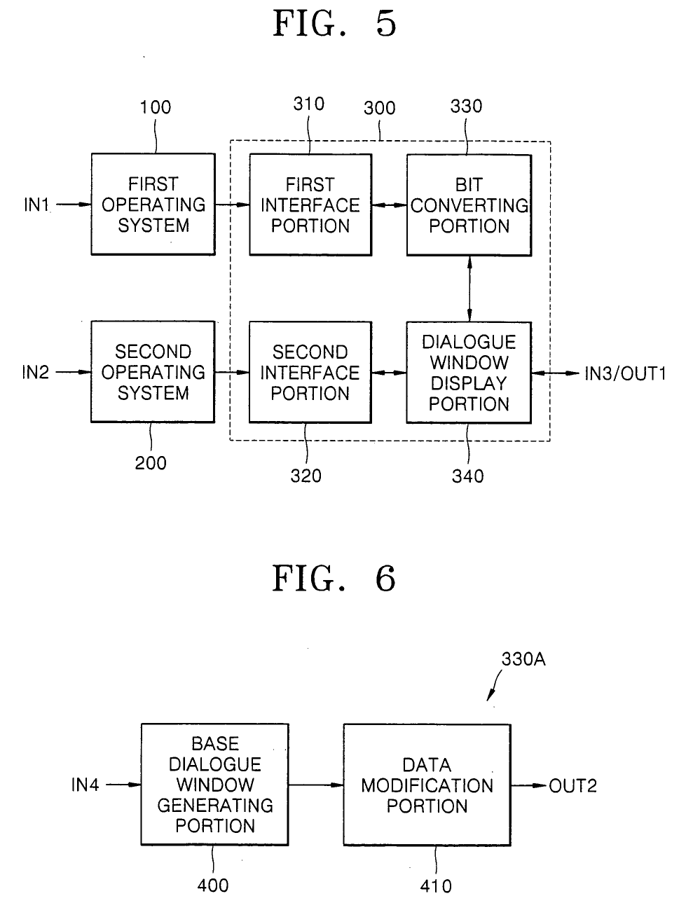

An apparatus for displaying a device driver dialogue window of a device will now be described with reference to the attached drawings. FIG. 5 is a functional block diagram of an apparatus displaying a device driver dialogue window of a device, according to an embodiment of the present invention. The device driver dialogue window display apparatus comprises a first operating system 100, a second operating system 200, and a device control portion 300 (i.e., a device driver 300).

In this example, the first operating system 100 can be an operating system, such as WINDOWS 95 or WINDOWS 98, supporting 16 bit device drivers. The first operating system 100 is requested according to an application program to display a 32 bit dialogue window of the device control portion 300 for exchange of information between a user and a device, through an input port IN1. In response to the IN1 request, the first operating system 100 transmits 16 bit dialogue window information, as corresponding to 32 bit dialogue window information, to the device control portion 300.

The second operating system 200 can be an operating system, such as WINDOWS 2000, WINDOWS NT, or WINDOWS XP, supporting 32 bit device drivers. The second operating system 200 is requested according to an application program to display a 32 bit dialogue window of the device control portion 300 for exchange of information between a user and a device, through an input port IN2. In case of the 32 bit operating system 200, in response to the IN2 request, the second operating system 200 transmits 32 bit dialogue window information to the device driver 300, which displays a 32 bit dialogue window.

As described above, in this example, the device control portion 300 is a device driver to control a device, such as a printer, a scanner, an all-in-one device, etc. The device control portion 300, as shown in FIG. 5, typically, comprises a first interface portion 310, a second interface portion 320, a bit converting portion 330, and a dialogue window display portion 340, which supports 32 bits. In case of the 16 bit operating system, first interface portion 310 receives the 16 bit dialogue window information including a 16 bit dialogue window command message of a predetermined device from the first operating system 100 supporting a 16 bit device control portion. For example, the first interface portion 310 receives the 16 bit dialogue window information that the user or an application program requests, as corresponding to the 32 bit dialogue window information, from the first 16 bit operating system 100, such as WINDOWS 95 or WINDOWS 98, and outputs the received 16 bit dialogue window information to the bit converting portion 330.

In case of the 32 bit operating system, the second interface portion 320 receives the 32 bit dialogue window information including a 32 bit dialogue window command message of a predetermined device from the second operating system 200 supporting a 32 bit device control portion. The second interface portion 320 receives the 32 bit dialogue window information to display the 32 bit dialogue window that the user or the application program requests, from the second 32 bit operating system 200, such as WINDOWS 2000, WINDOWS NT, or WINDOWS XP, and outputs the received 32 bit dialogue window information to the 32 bit dialogue window display portion 340.

The bit converting portion 330, in response to the input of the 16 bit dialogue window information, converts the received 16 bit dialogue window information to the 32 bit dialogue window information, and outputs the converted 32 bit dialogue window information to the 32 bit dialogue window display portion 340. According to an aspect of the invention, typically, the device driver 300 is configured at setup time as a first number of bits device driver dialogue window converter device driver depending on the number of bits supported by the operating system (e.g., in this example, as a 32 bit device driver dialogue window converter device driver by enabling the first interface portion 310).

FIG. 6 is a functional block diagram of the bit converting portion 330 of FIG. 5, according to an embodiment 330A of the present invention. Typically, a bit converting portion 330A comprises a base dialogue window generating portion 400 and a data modification portion 410. The base dialogue window generating portion 400 generates 32 bit base dialogue window information having no content of a 32 bit dialogue window and outputs the generated 32 bit base dialogue window information. The 32 bit base dialogue window information having no content of a 32 bit dialogue window is dialogue window information where a control message to the 32 bit dialogue window is not indicated (presented), as shown in FIG. 3. More particularly, response to 16 bit dialogue window information input from the first interface portion 310 through an input port IN4, the base dialogue window generating portion 400 generates 32 bit base dialogue information and outputs the generated 32 bit base dialogue window information and the input 16 bit dialogue window information, including the 16 bit dialogue window control message, to the data modification portion 410. FIG. 3 is a display screen image of a 32 bit base dialogue window displayed by the dialogue window display portion 340 according to the 32 bit base dialogue window information.

The data modification portion 410, in response to the input of the 32 bit base dialogue window information and the 16 bit dialogue window information, including the 16 bit dialogue window control message, modifies/converts the 16 bit dialogue window information to the 32 bit dialogue window information and outputs the modified 32 bit dialogue window information out of the output port OUT2 to the dialogue window display portion 340. In particular, the data modification portion 410, in response to the 32 bit base dialogue window information and the 16 bit dialogue window information including the 16 bit dialogue window control message input from the base dialogue window generating portion 400, modifies/converts the 16 bit dialogue window information to the 32 bit dialogue window information corresponding to the 32 bit base dialogue window and outputs the modified 32 bit dialogue window information to the dialogue window display portion 340 through the output portion OUT2.

Therefore, the dialogue window display portion 340 in response to the input 32 bit dialogue window information, or the input converted 32 bit dialogue window information, displays a 32 bit dialogue window corresponding to the input 32 bit dialogue window information or the input converted 32 bit dialogue window information. The dialogue window display portion 340, in response to the 32 bit dialogue window information input from the first interface portion 310 or the second interface portion 320, outputs a signal to display a 32 bit dialogue window corresponding to the 32 bit dialogue window through an output port OUT1. For example, the dialogue window display portion 340 instantly displays a 32 bit base dialogue window corresponding to the 32 bit base dialogue window information input from the first interface portion 310

Referring back to FIG. 5, according to an aspect of the invention, in case of a plurality of input 16 bit dialogue window information including control messages (a plurality of dialogue window page information), and a user input via an input portion IN3 to the dialogue window display portion 340 (e.g., a mouse selection of a selectable graphical display of a dialogue window item, such as the tabs in FIG. 4), in response to a request by the dialogue window display portion 340 for a 32 bit page information, the bit converting portion 330 requests the first interface portion 310 to provide one of a plurality of 16 bit page information of the 16 bit dialogue window information corresponding to the requested 32 bit page information, converts the requested 16 bit page information as a 32 bit page information, and outputs the converted 32 bit page information through the OUT3 port to display the converted 32 bit page information. The 32 bit page information as a dialogue window control message(s) is information of a dialogue window that a user desires to be displayed in a displayed 32 bit dialogue window for the control of a device. The detailed selectable graphical displays of tab items, such as layout, paper, or graphics, shown in FIG. 4 correspond to the converted 32 bit page information/control message of the 32 bit dialogue window.

Therefore, the bit converting portion 330, in response to the request by the dialogue window display portion 340 for a 16 bit page information, requests the first interface portion 310 to provide one of the plurality of 16 bit page information of the 16 bit dialogue window information corresponding to the requested 32 bit page information. The bit converting portion 330 receiving the requested 16 bit page information from the first interface portion 310 converts the input 16 bit page information to the 32 bit page information and outputs the converted 32 bit page information to the dialogue window display portion 340.

More particularly, the dialogue window display portion 340, in response to the request by the user for one of the 32 bit page information of the 32 bit dialogue window, requests the bit converting portion 330 or the second interface portion 320 to provide the converted 32 bit page information and the 32 bit page information, respectively, and displays the requested 32 bit page information by receiving the same, according to the process described above. The dialogue window display portion 340 receives the request by the user for one of the 32 bit page information of the 32 bit dialogue window through an input port IN3 and requests the bit converting portion 330 or the second interface portion 320 for the 32 bit page information. The dialogue window display portion 340 receives the 32 bit page information input from the converting portion 330 or the second interface portion 320 (as the case may be) and outputs a signal to display the input 32 bit page information through the output portion OUT1.

As described above, in the method and apparatus of displaying a device driver dialogue window of a device according to the present invention, regardless of the type of an operating system, such as WINDOWS 95 or WINDOWS 98, supporting 16 bit device drivers and WINDOWS 2000, WINDOWS NT, or WINDOWS XP, supporting 32 bit device drivers, a device driver dialogue window of a device can be displayed using a single device driver. More particularly, the present invention provides a single device driver that is able to display both a 16 bit dialogue window and a 32 bit dialogue window depending on the operating system. The present invention provides a method, comprising displaying a device driver dialogue window of a device using a single multi-enabled operating system interface device driver, thereby displaying the device driver dialogue window regardless of an operating system type. Although the above-described embodiments disclose a device driver converting 16-bit dialogue window information into 32-bit dialogue window information by a bit converting portion 330, the present invention is not limited to such a configuration and the present invention, if needed, may be implemented in a vice versa configuration to convert 32-bit dialogue window information into 16-bit dialogue window information. More particularly, the present invention provides a method and apparatus (computer) in which a device driver dialogue window of a device is displayable regardless of the number of bits supported by the operating system. An operating system supporting a first number of bits is requested to display the device driver dialogue window supporting a second number of bits, for exchange of information between a user and the device. In particular, the dialogue window information of the device in the first number of bits is received, via the operating system, either from an application program, including a user (as the case may be), or a user selection on the displayed dialogue window, and converted into dialogue window information in the second number of bits and then displayed. The processes of the present invention can be implemented in software and/or computing hardware.

Therefore, the present invention provides a computer, comprising a machine readable data storage storing a device driver displaying a device driver dialogue window regardless of a number of bits supported by an operating system of the computer by receiving a request from the operating system supporting a first number of bits device driver to display a second number of bits device driver dialogue window, generating a base (i.e., empty, a shell, or with no device interface content) second number of bits device driver dialogue window, converting the received first number of bits dialogue window information to a second number of bits dialogue window information, and displaying the second number of bits dialogue window information in the generated base second number of bits device driver dialogue window. More particularly, the present invention provides a machine readable data storage storing a device driver program controlling a computer to display a device driver dialogue window to interface with a device, according to a process comprising enabling an interface to input device driver dialogue window information, based upon a number of bits supported by an operating system, and displaying the device driver dialogue window corresponding to the input device driver dialogue window information according to the enabled interface.

Further, the present invention provides a computing device storing a device driver to interface with devices (i.e., by displaying a device driver dialogue window) regardless of a number of bits supported by an operating system of the computer, by enabling an interface to input device driver dialogue window information, based upon a number of bits supported by the operating system, and displaying the device driver dialogue window corresponding to the input device driver dialogue window information according to the enabled interface. More particularly, the device driver receives a request from the operating system supporting a first number of bits device driver to display a second number of bits device driver dialogue window, generates a shell second number of bits device driver dialogue window, converts the received first number of bits dialogue window information to a second number of bits dialogue window information, and displays the second number of bits dialogue window information in the generated shell second number of bits device driver dialogue window.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method of displaying a dialogue window of a device performed by a device control portion, the method comprising:
requesting an operating system supporting a 16 bit device control portion to display a 32 bit dialogue window for exchange of information between a user and a predetermined device;
receiving 16 bit dialogue window information of the device from the operating system;
converting the received 16 bit dialogue window information to 32 bit dialogue window information; and
displaying the 32 bit dialogue window corresponding to the converted 32 bit dialogue window information.

2. The method of claim 1, wherein the converting comprises:
generating 32 bit base dialogue window information having no content of the 32 bit dialogue window; and
modifying the 16 bit dialogue window information to the converted 32 bit dialogue window information, in response to the 32 bit base dialogue window information.

3. The method of claim 1, wherein the 16 bit dialogue window information comprises a plurality of 16 bit dialogue window page information and the displaying comprises displaying as the converted 32 bit dialogue window information, converted 32 bit page information in response to a request by the user for one of the 16 bit dialogue window page information in the 32 bit dialogue window.

4. An apparatus displaying according to dialogue window information a device dialogue window included in a device control portion, the apparatus comprising:
a first interface portion receiving 16 bit dialogue window information of the device from a first operating system supporting a 16 bit device control portion;
a second interface portion receiving 32 bit dialogue window information of the device from a second operating system supporting a 32 bit device control portion;
a bit converting portion converting the received 16 bit dialogue window information to converted 32 bit dialogue window information and outputting the converted 32 bit dialogue window information; and
a dialogue window display portion displaying a 32 bit dialogue window corresponding the converted 32 bit dialogue window information.

5. The apparatus of claim 4, wherein the bit converting portion comprises:
a base dialogue window generating portion generating a 32 bit base dialogue window information having no content of the 32 bit dialogue window and outputting the generated 32 bit base dialogue window information; and
a data modification portion modifying the received 16 bit dialogue window information to the converted 32 bit dialogue window information and outputting the converted 32 bit dialogue window information to the dialogue window display portion to display the 32 bit dialogue window corresponding to the converted 32 bit dialogue window information, in response to the 32 bit base dialogue window information.

6. The apparatus of claim 4, wherein the dialogue window information comprises a plurality of dialogue window page information, and
wherein the dialogue window display portion displays as the converted 32 bit dialogue window information, converted 32 bit page information or 32 bit page information, in response to a request by a user for one of the dialogue window page information by requesting the bit converting portion or the second interface portion to provide the converted 32 page information or the 32 bit page information, respectively.

7. The apparatus of claim 4, wherein the 16 bit dialogue window information comprises a plurality of 16 bit dialogue window page information, and
wherein the bit converting portion, in response to a request by the dialogue window display portion for a converted 32 bit dialogue window page information as the converted 32 bit dialogue window information, requests the first interface portion to provide one of the 16 bit dialogue window page information of the 16 bit dialogue window information, converts the requested 16 bit dialogue window page information to the converted 32 bit page dialogue window information, and outputs the converted 32 bit page information to the dialogue window display portion.

8. A machine readable data storage storing a device driver program controlling a computer to display a device driver dialogue window to interface with a device regardless of the number of bits supported by the computer operating system, according to a process comprising:
receiving a request from an operating system supporting a 16 bit device driver to display a 32 bit dialogue window for exchange of information between a user and the device;
receiving 16 bit dialogue window information of the device from the operating system;
converting the received 16 bit dialogue window information to 32 bit dialogue window information; and
displaying the 32 bit dialogue window corresponding to the converted 32 bit dialogue window information.

9. A computer, comprising:
a machine readable data storage storing a device driver program controlling the computer to interface with a device of the computer, according to a process comprising:
enabling an interface to input device driver dialogue window information, based upon a number of bits supported by an operating system, and
displaying the device driver dialogue window corresponding to the input device driver dialogue window information according to the enabled interface.

10. A method, comprising:
displaying a device driver dialogue window of a device using a single multi-enabled operating system interface device driver, thereby displaying the device driver dialogue window regardless of an operating system type.

11. A machine readable data storage storing a device driver program controlling a computer to display a device driver dialogue window to interface with a device, according to a process comprising:
enabling an interface to input device driver dialogue window information, based upon a number of bits supported by an operating system, and
displaying the device driver dialogue window corresponding to the input device driver dialogue window information according to the enabled interface.

12. The storage of claim 10, wherein the interface enabling comprises:
enabling a first number of bits interface or a first number of bits converter interface to the input device driver dialogue window information, based upon the number of bits supported by the operating system;
receiving, by the first number of bits converter interface, a first number of bits dialogue window information of the device from the operating system;
converting, by the first number of bits converter interface, the received first number of bits dialogue window information to a second number of bits dialogue window information; and
displaying the device deriver dialogue window corresponding to the converted second number of bits dialogue window information.
